(19) United States
(12) Patent Application Publication
(10) Pub. No.: US 2026/0311470 A1
(43) Pub. Date: Oct. 8, 2026

(54) IMAGE PROCESSING METHOD, PROGRAM, IMAGE PROCESSING SYSTEM, IMAGE PROCESSING DEVICE, AND DETECTION DEVICE

(71) Applicant: FANUC CORPORATION, Yamanashi (JP)

(72) Inventor: Yuta NAMIKI, Yamanashi (JP)

(73) Assignee: FANUC CORPORATION, Yamanashi (JP)

(21) Appl. No.: 19/481,533

(22) PCT Filed: May 12, 2023
(86) PCT No.: PCT/JP2023/017971

§ 371 Date: Nov. 4, 2025

(51) Int. Cl. G06V 10/776; G06V 10/774

(52) U.S. Cl. CPC G06V 10/776; G06V 10/774; G06V 2201/06; G06V 2201/07

(57) ABSTRACT

Provided are an image processing method, a program, an image processing system, an image processing device, and a detection device, whereby an object can be detected with high accuracy while maintaining processing efficiency. This image processing method comprises: a step (S11) for capturing an image of an object via a vision sensor; a first detection step (S12) for detecting or inspecting the object from the image, captured by the vision sensor, by using a first detector; an execution determination step (S13) for determining whether detection or inspection by the second detector is necessary; a second detection step (S14) for executing a detection process via the second detector when it is determined that detection or inspection by the second detector is necessary; and a determination step (S15) for comparing the output result of the first detector with the output result of the second detector to determine whether there is an error in the output result of the first detector.

### TECHNICAL FIELD

The present disclosure pertains to an image processing method, a program, an image processing system, an image processing device, and a detection device.

### BACKGROUND ART

A technique for using a vision sensor, which is attached to a robot or a prescribed position, to detect a target object and controlling operation of the robot is known. Because detecting a target object focuses on one feature such as an outline, there are cases where the feature is unable to be viewed due to, inter alia, a change in brightness, and detection is not possible. It is possible to learn appropriate features in accordance with the target object if deep learning or machine learning is used, and it is possible to improve the robustness of target object detection. Patent Document 1 or Patent Document 2 is an example of something that describes a technique pertaining to this type of learning.

### CITATION LIST

### Patent Document

Patent Document 1: Japanese Unexamined Patent Application, Publication No. 2020-21326
Patent Document 2: Japanese Unexamined Patent Application, Publication No. 2022-119754

### DISCLOSURE OF THE INVENTION

### Problems to Be Solved by the Invention

Hardware having comparatively high processing ability is required in order detect a target object using a model that has been trained by deep learning. Processing techniques that enable execution on hardware having low processing ability have been developed, but the recognition accuracy for a model is limited by the hardware performance. In contrast, there are also cases of desiring to prioritize processing speed or reduce the load on computers over accuracy in processing for detecting a target object.

The present disclosure is made in light of the problems described above, and an object of the present disclosure is to provide an image processing method, a program, an image processing system, an image processing device, and a detection device that enable a target object to be accurately detected while maintaining processing efficiency.

### Means for Solving the Problems

One aspect of the present disclosure is an image processing method for extracting a target object from an image, the method including: a step of using a visual sensor to capture the target object; a first detection step of using a first detector to detect or inspect the target object from an image captured by the visual sensor; an execution determination step of determining whether detection or inspection by a second detector is necessary; a second detection step of causing the second detector to execute detection processing in a case where it is assessed that the detection or inspection by the second detector is necessary; and an assessment step of assessing whether there is an error in an output result from the first detector by comparing the output result from the first detector with an output result from the second detector.

One aspect of the present disclosure is a program for causing a computer that executes processing for extracting a target object from an image to execute: an acquisition processing function of using a visual sensor to capture the target object; a first detection processing function of using a first detector to detect or inspect the target object from an image captured by the visual sensor; an execution determination function of determining whether detection or inspection by a second detector is necessary; a second detection processing function of causing the second detector to execute detection processing in a case where it is assessed that the detection or inspection by the second detector is necessary; and an assessment processing function of assessing whether there is an error in an output result from the first detector by comparing the output result from the first detector with an output result from the second detector.

One aspect of the present disclosure is an image processing system for extracting a target object from an image, the system provided with: an acquisition processing unit configured to use a visual sensor to capture the target object; a first detector configured to detect or inspect the target object from an image captured by the visual sensor; a second detector configured to detect or inspect the target object from an image captured by the visual sensor; an execution determination unit configured to determine whether detection or inspection by the second detector is necessary; and an appropriateness assessment unit configured to, in a case where it is assessed that detection or inspection by the second detector is necessary, assess whether there is an error in an output result from the first detector by comparing the output result from the first detector with an output result from the second detector.

One aspect of the present disclosure is an image processing device for extracting a target object from an image, the device provided with: an acquisition processing unit configured to use a visual sensor to capture the target object; a first detector configured to detect or inspect the target object from an image captured by the visual sensor; a second detector configured to detect or inspect the target object from an image captured by the visual sensor; an execution determination unit configured to determine whether detection or inspection by the second detector is necessary; and an appropriateness assessment unit configured to, in a case where it is assessed that detection or inspection by the second detector is necessary, assess whether there is an error in an output result from the first detector by comparing the output result from the first detector with an output result from the second detector.

One aspect of the present disclosure is a detection device for detecting or inspecting a target object, the device provided with: a first detector configured to detect or inspect the target object; a second detector configured to detect or inspect the target object; an execution determination unit configured to determine whether detection or inspection by the second detector is necessary; and an appropriateness assessment unit configured to, in a case where it is assessed that detection or inspection by the second detector is necessary, assess whether there is an error in an output result from the first detector by comparing the output result from the first detector with an output result from the second detector.

### BRIEF DESCRIPTION OF THE DRAWINGS

FIG. 1 is a view that illustrates a configuration of an image processing system according to the present embodiment;

FIG. 2 is a view that illustrates a functional configuration of the image processing system;

FIG. 3 is a flow chart that illustrates a flow of image processing by the image processing system; and

FIG. 4 is a view that illustrates a functional configuration of an image processing device according to a variation.

### PREFERRED MODE FOR CARRYING OUT THE INVENTION

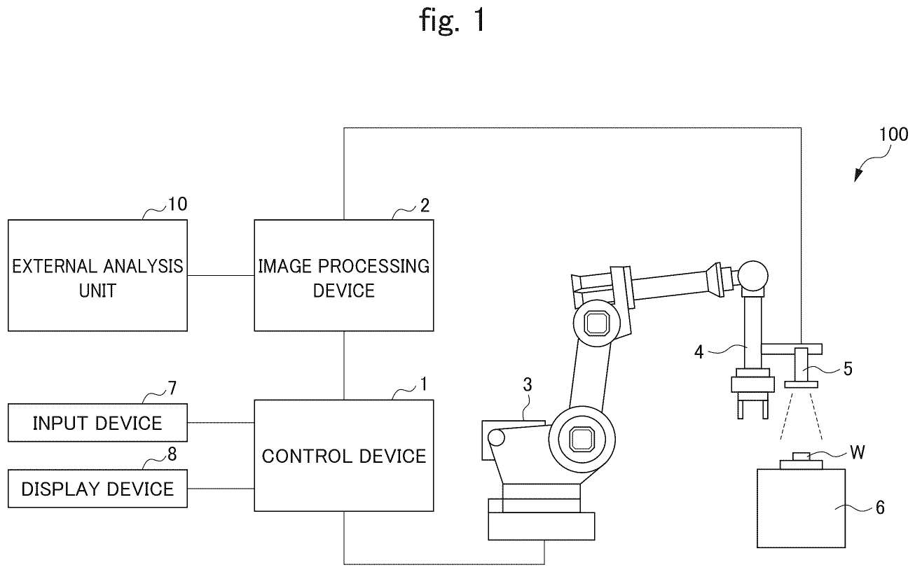

Description is given below regarding an example of an embodiment according to the present invention. FIG. 1 is a view that illustrates a configuration of an image processing system 100 according to the present embodiment. The image processing system 100 illustrated in FIG. 1 is a robot system that uses an image processing technique to machine a target object W.

The image processing system 100 according to the present embodiment is provided with a control device 1, an image processing device 2, a robot 3, an arm 4, a vision sensor 5, an input device 7, a display device 8, and an external

The control device 1 is a computer that controls operation by the robot 3, based on a prescribed program for machining the target object W that is a workpiece. The control device 1 controls operation by the robot 3 based on an image processing result outputted from the image processing device 2.

The image processing device 2 is a computer that controls the vision sensor 5 and performs image processing on an image that has been captured by the vision sensor 5. The image processing device 2 outputs a result of the image processing to the control device 1. The image processing device 2 may be configured by a plurality of computers.

The image processing device 2 may hold calibration data that defines, inter alia, a relative positional relationship between the vision sensor 5 and the robot 3, or internal parameters for the vision sensor 5. As a result, a position in an image that has been captured by the vision sensor 5 can be converted into a position in terms of a coordinate system (such as a robot coordinate system) that is fixed to a workspace.

For example, the robot 3 is an articulated robot, and a hand or a tool is attached to the tip end of the arm 4 that belongs to the robot 3. Under control by the control device 1, the robot 3 performs work such as machining or handling of the target object W on a mount 6. In addition, the vision sensor 5 is attached to the tip end of the arm 4 that belongs to the robot 3.

The type of the robot 3 is not particularly limited, and may be another type of robot. In addition, the vision sensor 5 does not need to be attached to the robot 3 and, for example, may be installed by being fixed to a prescribed position.

The vision sensor 5 captures the target object W under control by the image processing device 2. The vision sensor 5 may be a camera that captures grayscale images or color images, or may be, inter alia, a three-dimensional sensor or a stereo camera that can acquire a distance image or a three-dimensional point cloud. In the present embodiment, the vision sensor 5 is assumed to be calibrated.

The input device 7 is an interface through which an operator who uses the image processing system 100 performs various operations. The input device 7 may be configured by a button, a keyboard, or the like, may be configured by a touch panel display, or may be configured by a computer that is provided with an operation unit. In this manner, the configuration of the input device 7 is not particularly limited.

The display device 8 is an output device that uses an image or audio to notify an operator of information pertaining to usage of the image processing system 100. The display device 8 is configured by a display, a speaker, or the like. The configuration of the display device 8 is also not particularly limited.

The external analysis unit 10 performs image processing on an image captured by the vision sensor 5. The external analysis unit 10 is connected to the image processing device 2 via a dedicated line or a network such as the internet. The external analysis unit 10 is a second image processing device that is realized by a computer or cloud computing, and differs from the image processing device 2. The external analysis unit 10 performs image processing on the same image that the image processing device 2 has performed processing on.

A route by which the external analysis unit 10 acquires an image that has been captured by the vision sensor 5 is not particularly limited. The external analysis unit 10 may acquire an image via the image processing device 2, or may acquire an image via the robot 3 or the control device 1.

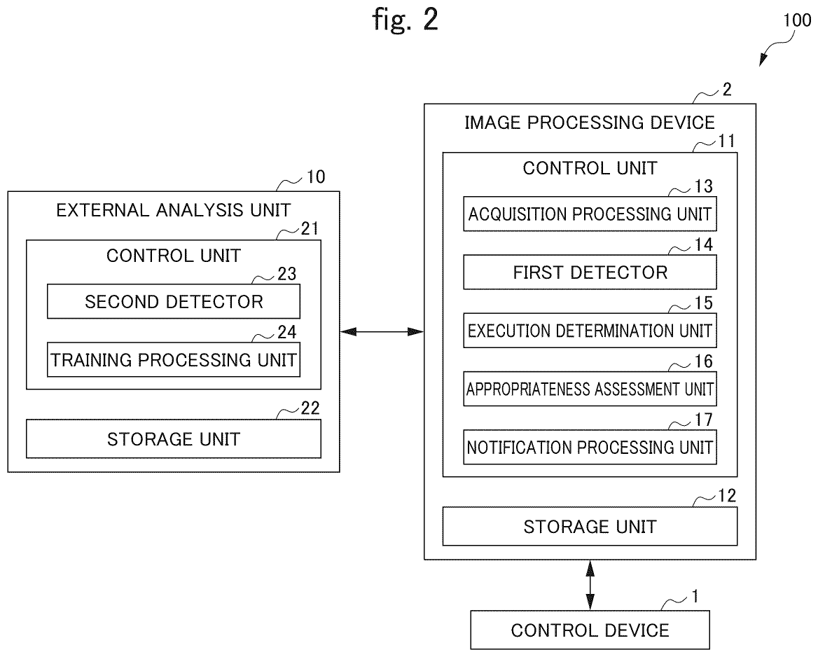

With reference to FIG. 2, description is given regarding an image processing function according to the present embodiment. FIG. 2 is a view that illustrates a functional configuration of the image processing system 100.

Firstly, description is given regarding the image processing device 2. As illustrated in FIG. 2, the image processing device 2 is provided with a control unit 11 and a storage unit 12. The control unit 11 is a processor such as a CPU (Central Processing Unit), and realizes various functions by executing a program stored in the storage unit 12.

The storage unit 12 is a storage device such as a ROM (Read-Only Memory) for storing, inter alia, an OS (Operating System) or an application program, a RAM (Random-Access Memory), or a hard disk drive or an SSD (Solid-State Drive) for storing various other items of information. For example, the storage unit 12 stores various items of information, such as a vision program for controlling the vision sensor 5.

As functional units that are executed by the control unit 11, the image processing device 2 according to the present embodiment is provided with an acquisition processing unit 13, a first detector 14, an execution determination unit 15, an appropriateness assessment unit 16, and a notification processing unit 17.

The acquisition processing unit 13 has an acquisition processing function of acquiring an image that is captured by the vision sensor 5. The acquisition processing unit 13 transmits to the vision sensor 5 a vision execution command that is based on a vision program that is set in advance, and causes the vision sensor 5 to capture the target object W. The vision program is a program that sets forth the details of processing pertaining to vision and is stored in the storage unit 12.

The first detector 14 has a first detection processing function of detecting or inspecting the target object W from an image acquired by the vision sensor 5. The detection or inspection may include detection of an anomaly or class classification in addition to extraction of a target object.

The first detector 14 executes processing for detecting the target object W from an image, based on a model generated by deep learning or machine learning, for example. Note that detection processing by the first detector 14 may use pattern matching using a model pattern that is for the target object W and is set in advance.

The execution determination unit 15 has an execution determination function of determining whether there is a necessity for detection or inspection by a second detector 23, which has relatively higher recognition accuracy than that of the first detector 14. Recognition accuracy being high or low can be determined based on an evaluation index for a model in the first detector 14. The evaluation index is not particularly limited. For the evaluation index, for example, it is possible to use recall (Recall) that indicates the probability that a prediction value according to the model is “positive” and thus correct, from among all data for which a correct value (a true value) is “positive” (Positive, a positive example). In addition, as an evaluation index that can be evaluated in one execution, for example, it is possible to give, inter alia, a proportion of matches with a model pattern in matching, whether a detected workpiece was successfully grasped, whether a detected number matches a number that is designated in advance, or the conviction level of a learning apparatus.

In the present embodiment, a criterion for a determination by the execution determination unit 15 can be selected from among a plurality of patterns. Description is given below regarding an example of a determination criterion.

The execution determination unit 15 may cause the second detector 23 to execute detection processing based on a determination by an operator who uses the image processing system 100. For example, in a case of desiring to improve the recognition accuracy of the first detector 14, an operator who has seen an output result from the first detector 14 would input from the input device 7 an instruction for causing detection processing by the second detector 23 to be executed. The execution determination unit 15 executes detection processing by the second detector 23 upon receiving the instruction from the operator through the input device 7. In this manner, it is possible to employ a determination result according to visual observation by an operator as a trigger for causing the second detector 23 to execute detection processing.

In addition, the execution determination unit 15 may cause the second detector 23 to execute detection processing based on a number of times that detection processing is executed with respect to the target object W from an image. For example, the execution determination unit 15 counts the number of times that detection processing by the first detector 14 is executed, and executes detection processing by the second detector 23 in a case of having reached a prescribed number of times.

In addition, the execution determination unit 15 may set a condition such that detection processing by the second detector 23 is executed at a specific timing, and cause detection processing by the second detector 23 to be executed in a case where the condition is satisfied. Description is given below regarding an example of the specific timing.

For example, in a case where the robot 3 is doing work on a production line, there is a need to operate at high speed due to a cycle time relationship, and thus it is difficult to execute detection processing by the second detector 23. Accordingly, if the robot 3 is not doing work on a production line, the execution determination unit 15 may set a condition for executing a determination of necessity by assuming that teaching is underway. As a result, it is possible to determine the appropriateness of an output result from the first detector 14 with reference to an output result by the second detector 23 during teaching. In addition, a configuration in which the image processing device 2 and the external analysis unit 10 are only connected by a network during teaching may be employed.

In addition, the execution determination unit 15 may employ, as a condition, executing detection processing by the second detector 23 at a specific date and time, based on a schedule that is set in advance.

In addition, it may be that the execution determination unit 15 assesses an output result from the first detector 14 based on an evaluation index that is set in advance, and causes detection processing by the second detector 23 to be executed. For example, the execution determination unit 15 monitors an output result from the first detector 14, and executes detection processing by the second detector 23 in a case where the output result deviates from an evaluation reference value.

The evaluation index is a degree of matching, for example. For example, a configuration may be employed in which the execution determination unit 15 monitors output results from the first detector 14 in chronological order, and determines necessity in a case where the degree of matching is trending down.

In addition, the execution determination unit 15 may determine necessity by employing the occurrence of a case where the first detector 14 could not detect the target object W as a condition.

Description was given above regarding examples of criteria for a determination by the execution determination unit 15. Note that there may be a configuration in which a criterion for a determination is set by the manufacturer in advance to one of the patterns described above, and an operator cannot change (select) a criterion for a determination by the execution determination unit 15. Next, description is given regarding the appropriateness assessment unit 16.

The appropriateness assessment unit 16 has an appropriateness assessment function of comparing an output result from the first detector 14 with an output result from the second detector 23, and assessing whether the output result from the first detector 14 is appropriate. For example, the appropriateness assessment unit 16 can compare XYZ coordinates for the target object W that is extracted from an image, and assess appropriateness in accordance with a level of deviation for the output result from the first detector 14 with respect to the output result from the second detector 23. In addition, the appropriateness assessment unit 16 may assess appropriateness based on the occurrence of a misdetection such as the target object W not being detected by the second detector 23 despite the target object W being detected by the first detector 14.

Next, description is given regarding the notification processing unit 17. The notification processing unit 17 has a notification processing function of executing processing for notifying an operator that an error has occurred in a case where the appropriateness assessment unit 16 has assessed that an error has arisen in an output result from the first detector 14. For example, the notification processing unit 17 displays information indicating that an error has occurred on a display screen belonging to the display device 8, or uses a speaker function that the display device 8 has to make a notification that an error has arisen.

Next, description is given regarding the external analysis unit 10. The external analysis unit 10 is provided with a control unit 21 and a storage unit 22. The control unit 21 is a processor such as a CPU (Central Processing Unit), and realizes various functions by executing a program stored in a storage unit 22. The storage unit 22 is a storage device such as a ROM for storing, inter alia, an OS or an application program, a RAM, or a hard disk drive or an SSD for storing various other items of information. For example, the storage unit 22 stores various items of information such as the vision program that controls the vision sensor 5, as well as training data for training the first detector 14.

The external analysis unit 10 in the present embodiment is provided with the second detector 23 and a training processing unit 24 as functional units that are executed by the control unit 21.

The second detector 23 has a second detection processing function of detecting or inspecting the target object W from an image acquired by the vision sensor 5. Higher recognition accuracy than that of the first detector 14 is set for the second detector 23. The second detector 23 executes processing for detecting the target object W from an image, based on a model generated by deep learning, for example. The second detector 23 can execute detection processing on the same image that the first detector 14 executed detection processing on.

The training processing unit 24 has a training processing function of executing training processing on the first detector 14. In the present embodiment, the training processing unit 24 executes training processing in a case where the appropriateness assessment unit 16 assessed that there was an error in an output result from the first detector 14. A case where there is an error in an output result from the first detector 14 includes a case where there is an insufficient number of detections used to train the model in the first detector 14, and the training is insufficient.

In the training processing, the training processing unit 24 stores, as training data, an image that is original data on which the second detector 23 has executed detection processing, and an output result that the second detector 23 outputted with respect to the image. The output result from the second detector 23 is a label that is associated with the image. Data stored as a label may include information such as the position and orientation or size of a target object included in the detection result, in addition to the output result from the second detector 23. The training processing unit 24 stores training data, which includes an image and a label with respect to the image, in the storage unit 22 in the external analysis unit 10. The training data may be stored in the storage unit 12 in the image processing device 2.

The training processing unit 24 retrains the model in the first detector 14, based on a dataset that is a set of training data stored in the storage unit 22. The training processing is with respect to the first detector 14 inside the image processing device 2, but is executed by the external analysis unit 10 that has higher processing performance than that of the image processing device 2. However, there is no limitation thereto, and the training processing may be executed by the image processing device 2. Note that training processing may be deep learning or may be machine learning that uses teaching data.

The training processing may be automatically executed by the external analysis unit 10, or may be executed due to a manual operation by an operator. In a case of automatic execution, the training processing unit 24 may perform retraining each time an error has arisen in an output result from the first detector 14, but may execute training processing upon being triggered by a prescribed number of items of training data being accumulated. In addition, even in a case where there is execution due to a manual operation by an operator, the operator can use a dataset that is a set of training data stored in the storage unit 22, and thus can easily and promptly start training processing such as machine learning or deep learning using the training processing unit 24.

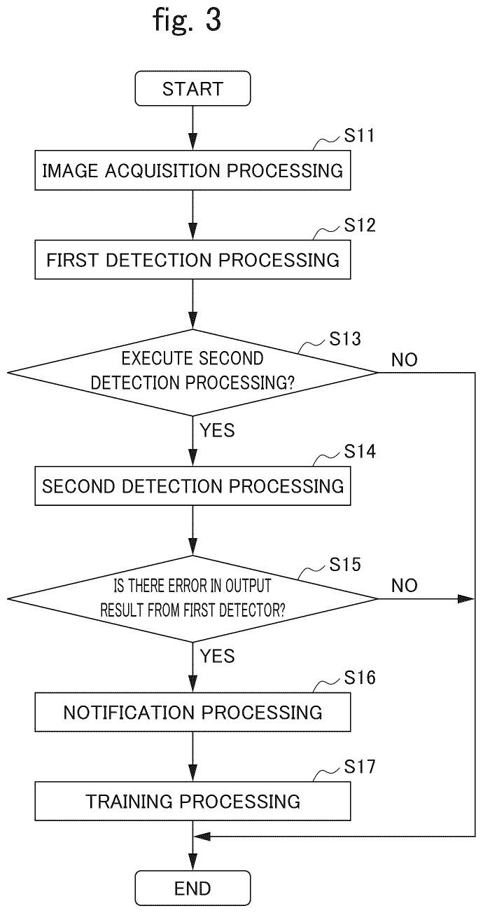

Next, with reference to FIG. 3, description is given regarding a flow of image processing. FIG. 3 is a flow chart that illustrates a flow of image processing by the image processing system 100. Note that the flow chart illustrated in FIG. 3 is purely an example, and the order or content of the flow can be changed, as appropriate.

In Step S11, the acquisition processing unit 13 executes processing for acquiring an image that has been captured by the vision sensor 5. Next, in Step S12, the first detector 14 executes detection processing for detecting or inspecting the target object W from the image acquired by the acquisition processing unit 13.

After the detection processing by the first detector 14, in Step S13, the execution determination unit 15 determines the necessity of executing detection processing by the second detector 23, based on a prescribed determination criterion.

In a case where the execution determination unit 15 has determined that there is no need to execute detection processing by the second detector 23, the processing ends without going through processing in Step S14 and thereafter (Step S13: No). In a case where the execution determination unit 15 has determined that there is a need to execute detection processing by the second detector 23, the processing proceeds to Step S14.

In Step S14, the second detector 23 executes detection processing for detecting or inspecting the target object W from the image acquired by the acquisition processing unit 13.

In Step S15, the appropriateness assessment unit 16 compares the output result from the first detector 14 with an output result from the second detector 23, and assesses whether the output result from the first detector 14 has an error.

In a case where the appropriateness assessment unit 16 has assessed that there is no error in the output result from the first detector 14, the processing ends without going through processing in Step S16 and thereafter (Step S15: No). In a case where the appropriateness assessment unit 16 has assessed that there is no error in the output result from the first detector 14, the processing proceeds to Step S16.

In Step S16, the notification processing unit 17 executes processing for notifying the operator that there was an error in the output result from the first detector 14.

In Step S17, in the storage unit 22 in the external analysis unit 10, the training processing unit 24 stores, as training data, the output result that is from the second detector 23 and results from execution with respect to the image for which the error arose in the output result from the first detector 14. In addition, in Step S17, the training processing unit 24 retrains the model in the first detector 14, based on a dataset that is a set of training data and is stored in the storage unit 22 or the storage unit 12. Note that, as described above, a trigger for executing training processing may be that a prescribed number of items of training data are accumulated, or may be based on an operation by an operator.

As described above, the image processing method according to the present embodiment includes: a step of using the vision sensor 5 that corresponds to a visual sensor to capture the target object W; a first detection step of using the first detector 14 to detect or inspect the target object W from an image captured by the vision sensor 5; an execution determination step of determining whether detection or inspection by the second detector 23 is necessary; a second detection step of causing the second detector 23 to execute detection processing in a case where it is assessed that the detection or inspection by the second detector 23 is necessary; and an assessment step of assessing whether there is an error in an output result from the first detector 14 by comparing the output result from the first detector 14 with an output result from the second detector 23.

In addition, a program according to the present embodiment causes execution of: an acquisition processing function of using the vision sensor 5 to capture the target object W; a first detection processing function of using the first detector 14 to detect or inspect the target object W from an image captured by the vision sensor 5; an execution determination function of determining whether detection or inspection by the second detector 23 is necessary; a second detection processing function of causing the second detector 23 to execute detection processing in a case where it is assessed that the detection or inspection by the second detector 23 is necessary; and an assessment processing function of assessing whether there is an error in an output result from the first detector 14 by comparing the output result from the first detector 14 with an output result from the second detector 23.

In addition, the image processing system 100 according to the present embodiment is provided with: the acquisition processing unit 13 that is configured to use the vision sensor 5 to capture the target object W; the first detector 14 that is configured to detect or inspect the target object W from an image captured by the vision sensor 5; the second detector 23 that is configured to detect or inspect the target object W from an image captured by the vision sensor 5; the execution determination unit 15 that is configured to determine whether detection or inspection by the second detector 23 is necessary; and the appropriateness assessment unit 16 that is configured to, in a case where it is assessed that detection or inspection by the second detector 23 is necessary, assess whether there is an error in an output result from the first detector 14 by comparing the output result from the first detector 14 with an output result from the second detector 23.

The image processing method, the program, and the image processing system 100 are configured as described above, whereby normally detection processing will be executed by the first detector 14, which has a low load on the computer and low power consumption and, in a case such as where an error arises in an output result from the first detector 14, it is possible to use an output result from the second detector 23, which has high recognition accuracy.

In addition, in the present embodiment, the image and the detection result from the second detector 23 are stored as training data in a case where it is assessed in the assessment step that there is an error. As a result, the training processing unit 24 can use a dataset that is a set of training data stored in the storage unit 22, and thus it is possible to omit processing for preparing a dataset by, inter alia, setting labels and it is possible to perform training processing efficiently.

In addition, in the present embodiment, training of the first detector 14 is re-executed while employing the image and the detection result from the second detector 23 as training data in a case where it is assessed in the assessment step that there is an error. As a result, training processing based on appropriate training data is automatically executed even if an operator does not perform an operation, and it is possible to realize improving recognition accuracy for the first detector 14 without incurring time and effort.

In addition, in the present embodiment, training is executed in the external analysis unit 10 that is cloud-based or is a computer that is separate from the computer for realizing the first detector 14. The external analysis unit 10 is configured by a computer that has higher performance than that of the image processing device 2, whereby it is possible to comfortably execute training processing that has a large load on a computer.

In addition, in the present embodiment, when it is assessed in the assessment step that there is an error, processing for making a notification that the error has occurred is executed. As a result, an operator can promptly ascertain that an error has arisen in an output result from the first detector 14.

In addition, in the present embodiment, it is possible to employ a configuration in which the necessity of detection processing by the second detector 23 is determined in the execution determination step in accordance with an operation by an operator. In a case of using this method, a determination that is based on the experience or a visual observation by the operator will be reflected to the determination of the necessity of detection processing by the second detector 23.

In addition, in the present embodiment, it is possible to employ a configuration in which the detection processing by the second detector 23 is determined to be necessary in the execution determination step in a case where detection processing by the first detector 14 is executed a prescribed number of times. In a case of using this method, the determination of the necessity of detection processing by the second detector 23 will be automatically executed when the prescribed number of times for detection processing is reached, and an operation by an operator can be omitted.

In addition, in the present embodiment, it is possible to employ a configuration in which detection processing by the second detector 23 will be determined to be necessary in the execution determination step in a case where a condition that is set in advance is satisfied. In a case of using this method, it is possible to set, to a condition for operating the second detector 23, a timing at which there is a high probability for an error by the first detector 14 occurring or a timing at which it would be good to check for the occurrence of an error.

In addition, in the present embodiment, it is possible to employ a configuration in which the detection processing by the second detector 23 is determined to be necessary in the execution determination step in a case where an output result from the first detector 14 satisfies a prescribed evaluation index. In a case of using this method, actual output results from the first detector 14 will be monitored, and determining necessity will be promptly executed when there is an evaluation index indicating a situation where an error is likely to occur.

In addition, in the present embodiment, the second detector 23 operates in the external analysis unit 10 that is cloud-based or is a computer that is separate from the computer for realizing the first detector 14. The external analysis unit 10 is configured by a computer that has higher performance than that of the image processing device 2, whereby it is possible to cause the second detector 23, which has higher recognition accuracy and a greater computer load than that of the first detector 14, to operate comfortably.

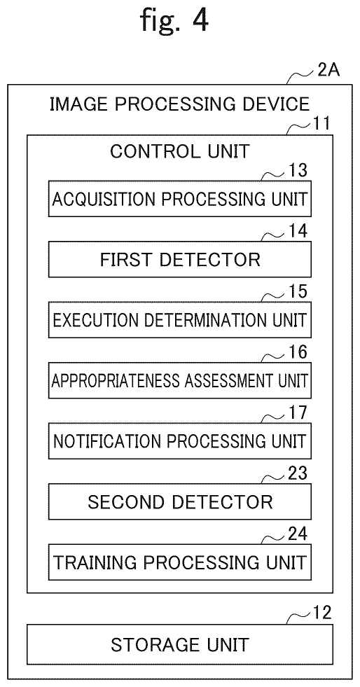

Next, description is given regarding a variation of the embodiment described above. FIG. 4 is a view that illustrates a functional configuration of an image processing system 2A according to the variation. Note that the variation illustrated in FIG. 4 results from combining the image processing device 2 according to the above-described embodiment and the external analysis unit 10 into the image processing system 2A, which is configured by one computer. Note that, in the following description, the same reference symbols are added to configurations that are the same as configurations in the embodiment described above, and detailed description thereof is omitted.

In the variation illustrated in FIG. 4, the image processing system 2A is provided with an acquisition processing unit 13, a first detector 14, an execution determination unit 15, an appropriateness assessment unit 16, a notification processing unit 17, a second detector 23, and a training processing unit 24. In other words, the first detector 14 and the second detector 23 are present in the same image processing system 2A, and training processing with respect to the first detector 14 is executed by the image processing system 2A.

In the present variation, normally detection processing is executed by the first detector 14, which has a low load on the computer and low power consumption and, in a case where there is a high probability of an error arising in an output result from the first detector 14, it is possible to use an output result from the second detector 23, which has high recognition accuracy. In addition, in a case where execution is on the same hardware, the first detector 14 operates at higher speed than the second detector 23 and has lower memory usage. Therefore, it is possible to shorten the amount of operation time in comparison to a case of executing detection processing only by the second detector 23.

Description was given above regarding embodiments of the present invention, but there is no limitation to the configurations of the embodiment or variation that are described above. For example, a configuration such as the execution determination unit 15 or the appropriateness assessment unit 16 may be located in the external analysis unit 10. In addition, the image processing system 100 may machine the target object W using a machine tool instead of the robot 3. In this case, the control device 1 becomes a numerical control device.

In addition, the above-described image processing device 2 and external analysis unit 10, or image processing system 2A, can be realized by hardware, software, or a combination of these. In addition, a control method performed by the above-described image processing device 2 and external analysis unit 10, or image processing system 2A, can be realized by hardware, software, or a combination of these. Being realized by software means being realized by a computer reading and executing a program.

A program can be stored using various types of non-transitory computer-readable mediums and supplied to a computer. A non-transitory computer-readable medium includes various types of tangible storage mediums. An example of a non-transitory computer-readable medium includes a magnetic recording medium (for example, a floppy disk, magnetic tape, or a hard disk drive), a magneto-optical recording medium (for example, a magneto-optical disk), a CD-ROM (read-only memory), CD-R, CD-R/W, and a semiconductor memory (for example, a mask ROM, a programmable ROM (PROM), an erasable PROM (EPROM), a flash ROM, or a random-access memory (RAM) ).

Each embodiment described above is a suitable embodiment of the present invention, but the scope of the present invention is not limited to only the embodiments described above, and the present invention can be worked in forms resulting from making various modifications within a range that does not deviate from the substance of the present invention.

For example, a detector that detects or inspects a target object from an image acquired by a vision sensor is used as each of the first detector and the second detector in the embodiments described above, and the present disclosure is applied to detection in image processing, but there is no limitation thereto, and the present disclosure is widely applicable to a detection device in other processing apart from image processing. In other words, it is possible to give, as another embodiment of the present disclosure, a detection device 100 for detecting or inspecting a target object W, the detection device 100 provided with: the first detector 14 that detects or inspects the target object W; the second detector 23 that detects or inspects the target object W; the execution determination unit 15 that determines whether detection or inspection by the second detector 23 is necessary; and the appropriateness assessment unit 16 that, in a case where it is assessed that detection or inspection by the second detector 23 is necessary, assesses whether there is an error in an output result from the first detector 14 by comparing the output result from the first detector 14 with an output result from the second detector 23.

More specifically, in another embodiment of the present disclosure, as a combination of a first detector and a second detector, it is possible to use a combination of a force sensor attached to a hand of a robot and a torque sensor attached to each joint of the robot. From respective outputs from the force sensor and the torque sensors, it is possible to detect the state of the robot or the type of work by the robot, and thus an effect similar to that of the embodiment described above is achieved even in this embodiment.

In addition, in another embodiment of the present disclosure, it is possible to use a combination of a microphone and a vibration sensor as a combination of a first detector and a second detector. It is possible to detect the state of the robot or a situation in the periphery of the robot from respective outputs from the microphone and the vibration sensors, and thus an effect similar to the embodiments described above is achieved even in this embodiment.

In relation to embodiments and variations described above, the following additional remarks are also disclosed.

### Additional Remark 1

An image processing method for extracting a target object (W) from an image, the method including:
a step of using a visual sensor (5) to capture the target object (W);
a first detection step of using a first detector (14) to detect or inspect the target object (W) from an image captured by the visual sensor (5);
an execution determination step of determining whether detection or inspection by a second detector (23) is necessary;
a second detection step of causing the second detector (23) to execute detection processing in a case where it is assessed that the detection or inspection by the second detector (23) is necessary; and
an assessment step of assessing whether there is an error in an output result from the first detector (14) by comparing the output result from the first detector (14) with an output result from the second detector (23).

### Additional Remark 2

In the above-described image processing method, the image and a detection result from the second detector (23) are stored as training data in a case where it is assessed in the assessment step that there is an error.

### Additional Remark 3

In the above-described image processing method, training of the first detector (14) is re-executed while employing the image and a detection result from the second detector (23) as training data in a case where it is assessed in the assessment step that there is an error.

### Additional Remark 4

In the above-described image processing method, the training is executed in a cloud or by a computer (10) that is separate from a computer for realizing the first detector (14).

### Additional Remark 5

In the above-described image processing method, when it is assessed in the assessment step that there is an error, processing for making a notification that the error has occurred is executed.

### Additional Remark 6

In the above-described image processing method, the necessity of the detection processing by the second detector (23) is determined in the execution determination step in accordance with an operation by an operator.

### Additional Remark 7

In the above-described image processing method, the detection processing by the second detector (23) is determined to be necessary in the execution determination step in a case where detection processing by the first detector (14) is executed a prescribed number of times.

### Additional Remark 8

In the above-described image processing method, the detection processing by the second detector (23) is determined to be necessary in the execution determination step in a case where a condition that is set in advance is satisfied.

### Additional Remark 9

In the above-described image processing method, the detection processing by the second detector (23) is determined to be necessary in the execution determination step in a case where the output result from the first detector (14) has satisfied a prescribed evaluation index.

### Additional Remark 10

In the above-described image processing method, the second detector (23) operates in a cloud or in a computer (10) that is separate from a computer for realizing the first detector (14).

### Additional Remark 11

A program for causing a computer (2) that executes processing for extracting a target object (W) from an image to execute:
an acquisition processing function of using a visual sensor (5) to capture the target object (W);
a first detection processing function of using a first detector (14) to detect or inspect the target object (W) from an image captured by the visual sensor (5);
an execution determination function of determining whether detection or inspection by a second detector (23) is necessary;
a second detection processing function of causing the second detector (23) to execute detection processing in a case where it is assessed that the detection or inspection by the second detector (23) is necessary; and
an assessment processing function of assessing whether there is an error in an output result from the first detector (14) by comparing the output result from the first detector (14) with an output result from the second detector (23).

### Additional Remark 12

An image processing system (100) for extracting a target object (W) from an image, the system including:
an acquisition processing unit (13) configured to use a visual sensor (5) to capture the target object (W);
a first detector (14) configured to detect or inspect the target object (W) from an image captured by the visual sensor (5);
a second detector (23) configured to detect or inspect the target object (W) from an image captured by the visual sensor (5);
an execution determination unit (15) configured to determine whether detection or inspection by the second detector (23) is necessary; and
an appropriateness assessment unit (16) configured to, in a case where it is assessed that detection or inspection by the second detector (23) is necessary, assess whether there is an error in an output result from the first detector (14) by comparing the output result from the first detector (14) with an output result from the second detector (23).

### Additional Remark 13

An image processing device (2A) for extracting a target object (W) from an image, the device including: an acquisition processing unit (13) configured to use a visual sensor (5) to capture the target object (W);
a first detector (14) configured to detect or inspect the target object (W) from an image captured by the visual sensor (5);
a second detector (23) configured to detect or inspect the target object (W) from an image captured by the visual sensor (5);
an execution determination unit (15) configured to determine whether detection or inspection by the second detector (23) is necessary; and
an appropriateness assessment unit (16) configured to, in a case where it is assessed that detection or inspection by the second detector (23) is necessary, assess whether there is an error in an output result from the first detector (14) by comparing the output result from the first detector (14) with an output result from the second detector (23).

### Additional Remark 14

A detection device (100) for detecting or inspecting a target object (W), the device including:
a first detector (14) configured to detect or inspect the target object (W);
a second detector (23) configured to detect or inspect the target object (W);
an execution determination unit (15) configured to determine whether detection or inspection by the second detector (23) is necessary; and
an appropriateness assessment unit (16) configured to, in a case where it is assessed that detection or inspection by the second detector (23) is necessary, assess whether there is an error in an output result from the first detector (14) by comparing the output result from the first detector (14) with an output result from the second detector (23).

### EXPLANATION OF REFERENCE NUMERALS

1 Control device
   2 Image processing device

### 3 Robot

### 4 Arm

5 Vision sensor
10 External analysis unit
13 Acquisition processing unit
14 First detector
15 Execution determination unit
16 Appropriateness assessment unit
17 Notification processing unit
23 Second detector
24 Training processing unit
W Target object
100 Image processing system

1. An image processing method for extracting a target object from an image, the method comprising:
a step of using a visual sensor to capture the target object;
a first detection step of using a first detector to detect or inspect the target object from an image captured by the visual sensor;
an execution determination step of determining whether detection or inspection by a second detector is necessary;
a second detection step of causing the second detector to execute detection processing in a case where it is assessed that the detection or inspection by the second detector is necessary; and
an assessment step of assessing whether there is an error in an output result from the first detector by comparing the output result from the first detector with an output result from the second detector.

2. The image processing method according to claim 1, wherein the image and a detection result from the second detector are stored as training data in a case where it is assessed in the assessment step that there is an error.

3. The image processing method according to claim 1, wherein training of the first detector is re-executed while employing the image and a detection result from the second detector as training data in a case where it is assessed in the assessment step that there is an error.

4. The image processing method according to claim 3, wherein the training is executed in a cloud or by a computer that is separate from a computer for realizing the first detector.

5. The image processing method according to claim 1, wherein, when it is assessed in the assessment step that there is an error, processing for making a notification that the error has occurred is executed.

6. The image processing method according to claim 1, wherein the necessity of the detection processing by the second detector is determined in the execution determination step in accordance with an operation by an operator.

7. The image processing method according to claim 1, wherein the detection processing by the second detector is determined to be necessary in the execution determination step in a case where detection processing by the first detector is executed a prescribed number of times.

8. The image processing method according to claim 1, wherein the detection processing by the second detector is determined to be necessary in the execution determination step in a case where a condition that is set in advance is satisfied.

9. The image processing method according to claim 1, wherein the detection processing by the second detector is determined to be necessary in the execution determination step in a case where the output result from the first detector has satisfied a prescribed evaluation index.

10. The image processing method according to claim 1, wherein the second detector operates in a cloud or in a computer that is separate from a computer for realizing the first detector.

11. A program for causing a computer that executes processing for extracting a target object from an image to execute:
an acquisition processing function of using a visual sensor to capture the target object;
a first detection processing function of using a first detector to detect or inspect the target object from an image captured by the visual sensor;
an execution determination function of determining whether detection or inspection by a second detector is necessary;
a second detection processing function of causing the second detector to execute detection processing in a case where it is assessed that the detection or inspection by the second detector is necessary; and
an assessment processing function of assessing whether there is an error in an output result from the first detector by comparing the output result from the first detector with an output result from the second detector.

12. An image processing system for extracting a target object from an image, the system comprising:
an acquisition processing unit configured to use a visual sensor to capture the target object;
a first detector configured to detect or inspect the target object from an image captured by the visual sensor;
a second detector configured to detect or inspect the target object from an image captured by the visual sensor;
an execution determination unit configured to determine whether detection or inspection by the second detector is necessary; and
an appropriateness assessment unit configured to, in a case where it is assessed that detection or inspection by the second detector is necessary, assess whether there is an error in an output result from the first detector by comparing the output result from the first detector with an output result from the second detector.

13. An image processing device for extracting a target object from an image, the device comprising:
an acquisition processing unit configured to use a visual sensor to capture the target object;
a first detector configured to detect or inspect the target object from an image captured by the visual sensor;
a second detector configured to detect or inspect the target object from an image captured by the visual sensor;
an execution determination unit configured to determine whether detection or inspection by the second detector is necessary; and
an appropriateness assessment unit configured to, in a case where it is assessed that detection or inspection by the second detector is necessary, assess whether there is an error in an output result from the first detector by comparing the output result from the first detector with an output result from the second detector.

14. A detection device for detecting or inspecting a target object, the device comprising:
a first detector configured to detect or inspect the target object;
a second detector configured to detect or inspect the target object;
an execution determination unit configured to determine whether detection or inspection by the second detector is necessary; and
an appropriateness assessment unit configured to, in a case where it is assessed that detection or inspection by the second detector is necessary, assess whether there is an error in an output result from the first detector by comparing the output result from the first detector with an output result from the second detector.
